(19) United States
(12) Patent Application Publication
(10) Pub. No.: US 2022/0335573 A1
(43) Pub. Date: Oct. 20, 2022

(54) IMAGE SUPER-RESOLUTION RECONSTRUCTION METHOD AND DEVICE FEATURING LABELED DATA SHARPENING

(71) Applicant: AEROSPACE INFORMATION RESEARCH INSTITUTE, CAS, Beijing (CN)

(72) Inventors: Junjie ZHU, Beijing (CN); Xiangtao FAN, Beijing (CN); Xiaoping DU, Beijing (CN); Jian LIU, Beijing (CN)

(73) Assignee: AEROSPACE INFORMATION RESEARCH INSTITUTE, CAS, Beijing (CN)

(21) Appl. No.: 17/636,044

(22) PCT Filed: Sep. 11, 2020
(86) PCT No.: PCT/CN2020/114881

§ 371 Date: Feb. 17, 2022

(30) Foreign Application Priority Data
Sep. 17, 2019 (CN) 201910879915.7

(51) Int. Cl. G06T 3/40

(52) U.S. Cl. CPC G06T 3/4076; G06T 3/4046

(57) ABSTRACT

The embodiments of the application provide an image super-resolution reconstruction method and device featuring labeled data sharpening. The method comprises: establishing a deep neural network for image reconstruction from low resolution to high resolution, obtaining low-resolution sample data by sub-sampling and Sobel operator calculation, and then sharpening labeled data to a certain extent so that edges of the labeled data are clearer and object features are easier to see. A model is obtained by training the deep neural network, and the model is used to perform super-resolution processing on the image to obtain an image with a higher resolution. The obtained image has a clear texture, the resolution and definition are significantly improved, and the quality evaluation indexes of the image are better.

### TECHNICAL FIELD

The application relates to computer image restoration technologies, in particular to an image super-resolution restoration technology based on deep learning.

### BACKGROUND ART

Deep learning has developed rapidly in the field of multimedia processing in recent years, and the image super-resolution restoration technology based on deep learning has gradually become the mainstream technology. One of the assumptions of this technology is that there is a mapping relationship between low-resolution image samples and high-resolution image labeled data. The mapping relationship between the two types of data is established by means of the learning function of a neural network, so as to realize the image super-resolution function. An image super-resolution reconstruction algorithm based on a convolutional neural network has verified the superior performance of deep learning in image super-resolution, and has proved that the convolutional neural network is capable of mapping low-resolution images to high-resolution images. Using a deep neural network for image super-resolution is pioneering scientific research.

Due to massive convolution operations, deep learning using a convolutional neural network inevitably leads to smoothing of image pixels, thus making a texture fuzzy to a certain extent. In view of this, someone turned sample data into multi-channel data, not just color images of three channels, but data with various types of information obtained from an original sample image through image processing, and data of 18 channels obtained by conducting three types of interpolation and five types of sharpening on the sample data were used as sample input data, so as to expand the number of channels of input sample data in order to retain the texture information of the data, which has the disadvantages of too many input channels and unsatisfying effects. Someone used a 20-layer deep residual neural network. The residual network is characterized in that the network is used to describe the data difference between adjacent layers, which is simple and facilitates convergence. By adopting a deep residual network structure and using a sub-pixel convolution layer to realize the reconstruction of a single image, the reconstruction efficiency is improved, the reconstruction time is shortened, and the texture effect of a super-resolution result image is improved. It has been proved that the method for realizing super-resolution by using an adversarial network is a better method. An image super-resolution technology using a deep neural network has become a popular technology and has a good application prospect.

The above discussions mainly focus on two aspects, one is the selection of input sample data, and the other is the design of a network model. These documents have promoted the progress of image super-resolution. However, although the studies on these two aspects have improved the resolution and definition of images to a certain extent, there is still a certain gap from the original data, and the definition and resolution of images may be further improved.

### SUMMARY OF THE INVENTION

In view of the shortcomings of the prior art, the application proposes an image super-resolution reconstruction method and device featuring labeled data sharpening. By sharpening the labeled data to a certain extent, edges of the labeled data are clearer and object features are easier to see. A model is obtained by training a deep neural network, and the model is used to perform super-resolution processing on an image to obtain an image with a higher resolution; and the obtained image has a clear texture, the resolution and definition are significantly improved, and the quality evaluation indexes of the image are better. The method of the application may effectively solve the above problems of the existing image super-resolution restoration technology.

The application provides an image super-resolution reconstruction method. The method comprises: inputting sample data into a pre-established super-resolution image generation neural network, the sample data being obtained by low-resolution processing of an original image; extracting, by the super-resolution image generation neural network, image features according to a low-resolution image input by the sample data, and then reconstructing the image according to the extracted image features to obtain an output super-resolution image; adjusting parameters of the super-resolution image generation neural network if a similarity between the super-resolution image and labeled data does not reach a preset standard, the labeled data being obtained by sharpening the original image; and inputting the low-resolution image into a trained super-resolution image generation neural network to obtain a super-resolution image.

Preferably, the super-resolution image generation neural network involves multi-layer convolution calculation, and at least part of the multi-layer convolution calculation adopts narrow convolution.

Preferably, the super-resolution image generation neural network involves multi-layer convolution calculation, and each layer of convolution calculation adopts local response normalization (LRN).

Preferably, a method for making the sample data comprises: performing sub-sampling calculation on an original image to obtain a low-resolution image; performing Sobel operator filtering calculation on the obtained low-resolution image to obtain a Sobel edge image; and performing interpolation calculation on data of four bands, that is, data of red, green and blue bands of the low-resolution image and data of the Sobel edge image, to obtain an image with the same resolution as the original image as the sample data.

Preferably, a method for making the labeled data comprises: obtaining the labeled data from an original image through sharpening calculation, wherein the sharpening calculation is conducted through USM sharpening, and the USM sharpening is conducted by the following parameters: the threshold value is 3, the radius is 1-1.2, and the number is 20%-25%.

In another aspect, the application provides an image super-resolution reconstruction device. The device comprises: a sample data generation module for performing low-resolution processing on an original image to obtain training sample data of a super-resolution image generation neural network module, a labeled data generation module for sharpening the original image to obtain training labeled data of the super-resolution image generation neural network module, and a super-resolution image generation neural network module for training according to the sample data and the labeled data; wherein an input image is calculated by the trained super-resolution image generation neural network module to obtain a super-resolution image of the input image.

Preferably, the super-resolution image generation neural network comprises multiple layers of convolution calculation subunits, and at least part of the multiple layers of convolution calculation subunits adopt narrow convolution.

Preferably, the super-resolution image generation neural network comprises multiple layers of convolution calculation subunits, and each layer of convolution calculation subunits adopts local response normalization (LRN).

Preferably, the device comprises: a subunit for performing sub-sampling calculation on an original image to obtain a low-resolution image; a subunit for performing Sobel operator filtering calculation on the obtained low-resolution image to obtain a Sobel edge image; and a subunit for performing interpolation calculation on data of four bands, that is, data of red, green and blue bands of the low-resolution image and data of the Sobel edge image, to obtain an image with the same resolution as the original image as the sample data.

Preferably, the labeled data generation module adopts USM sharpening, and the USM sharpening is conducted by the following parameters: the threshold value is 3, the radius is 1-1.2, and the number is 20%-25%.

Compared with the prior art, the technical scheme adopted by the application has the following technical advantages:

By sharpening the labeled data to a certain extent, edges of the labeled data are clearer and object features are easier to see; a model is obtained by training a deep neural network, and the model is used to perform super-resolution processing on the image to obtain an image with a higher resolution; and the obtained image has a clear texture, the resolution and definition are significantly improved, and the quality evaluation indexes of the image are better.

### BRIEF DESCRIPTION OF THE DRAWINGS

The embodiments of this specification may be made clearer by describing them with the drawings:

FIG. 1 is a diagram of a neural network model used in an image super-resolution reconstruction method featuring labeled data sharpening provided by an embodiment of the application;

FIG. 2 is a data conversion and flow diagram of an image super-resolution reconstruction method featuring labeled data sharpening;

FIG. 3 is a module diagram of an image super-resolution reconstruction device;

FIG. 4 is a comparison diagram of original data and sample data obtained by sub-sampling and then interpolation;

FIG. 5 is a comparison diagram of super-resolution results obtained when RGB channels serve as input data, when Sobel edge+RGB channels serve as input data, and when labeled data are sharpened;

FIG. 6 is a comparison diagram of original data and super-resolution results; and

FIG. 7 is an enlarged comparison diagram of original data and super-resolution results.

### DETAILED DESCRIPTION OF THE INVENTION

Embodiments of the technical scheme of the application will be described in detail below with reference to the accompanying drawings.

It should be noted that, unless otherwise specified, the technical terms or scientific terms used in the application shall have the general meaning understood by those skilled in the field to which the application belongs.

The purpose of image super-resolution is to improve the resolution and definition of images, so as to make object features in the images easier to see and the texture clearer. In the application, by sharpening labeled data to a certain extent, edges of the labeled data are clearer and object features are easier to see; a model is obtained by training a deep neural network, and the model is used to perform super-resolution processing on the image to obtain an image with a higher resolution; and the obtained image has a clear texture, the resolution and definition are significantly improved, and the quality evaluation indexes of the image are better.

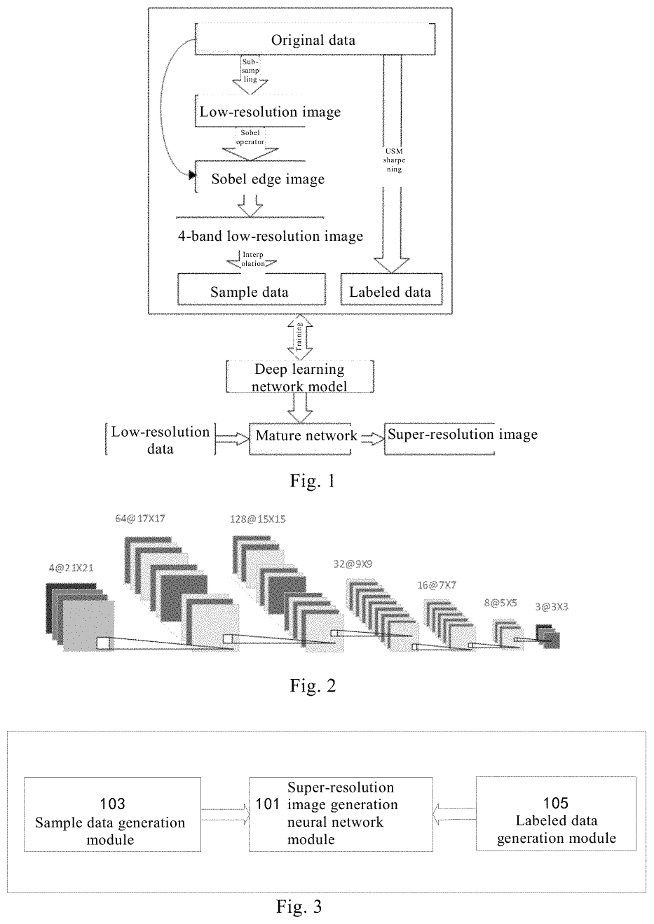

FIG. 1 is a diagram of a neural network model used in an image super-resolution reconstruction method featuring labeled data sharpening provided by an embodiment of the application. In this embodiment, a deep learning network model is first designed for image super-resolution calculation, then sample data and labeled data are made, then the network is trained with the sample data and the labeled data to obtain a mature super-resolution network, and finally a low-resolution image is input into the trained network to obtain an image super-resolution result.

As shown in FIG. 1, an original image is subjected to low-resolution processing, and an obtained image is taken as sample data.

Simultaneous with low-resolution processing or before or after low-resolution processing, the original image is sharpened, and the obtained image is used as labeled data.

A pre-established super-resolution image generation neural network is trained with the sample data and the labeled data, and the pre-established super-resolution image generation neural network may extract image features according to the input low-resolution image, then reconstruct the image according to the extracted image features, and output the super-resolution image.

The low-resolution image is input into the trained super-resolution image generation neural network to generate the output super-resolution image.

In one embodiment, the image super-resolution reconstruction process featuring labeled data sharpening is as follows:

### 1. Design a Super-Resolution Image Generation Neural Network Model

In one example, the designed super-resolution image generation neural network model is a convolutional neural network model. Specifically, the super-resolution image generation neural network model may be a 6-layer convolutional neural network model. The input data may be data of 4 channels composed of color images and a Sobel channel A first convolution layer with 64 features is obtained through convolution with a 5×5 template, a second convolution layer with 128 features is obtained through convolution with a 3×3 convolution template, a third convolution layer with 32 features is obtained through convolution with a 7×7 template, a fourth convolution layer with 16 features is obtained through convolution with a 3×3 template, a fifth convolution layer with 8 features is obtained through convolution with a 3×3 template, and a sixth convolution layer with 3 features is obtained through convolution with a 3×3 template. The sixth layer is the final super-resolution result. Refer to FIG. 2 for the convolutional neural network model.

In one example, each layer should be subjected to LRN, otherwise the network model will be prone to over-fitting. In this embodiment, in the convolution calculation process of each layer, a narrow convolution strategy instead of a constant convolution strategy is adopted, so the image becomes smaller after each layer of convolution, for example, a picture with the size of 21×21 serving as the input data will, after being output through the network model, eventually turn out to be a size of 3×3.

With regard to the normalization in this embodiment, that is, network regularization, the inventor believes that a deep neural network without regularization is prone to over-fitting, which is often caused by both data and model. Specifically, over-fitting may occur when data has a small amount or data are incomplete or atypical, or a model is too complicated. Network regularization may effectively eliminate over-fitting. LRN may locally normalize a layer of the network model to obtain a local normalized layer, which was first defined by an AlexNet network. This method may effectively reduce over-fitting. The calculation formula is as follows:

$${b}_{x , y}^{i} = {a}_{x , y}^{i} / {( k + α {\sum }_{j = max ( 0 , i - n / 2 )}^{min ( N - 1 , i + n \text{/2} )} {( {a}_{x , y}^{j} )}^{2} )}^{β}$$

where b_{x,y}ⁱ is a normalized value, i is an input channel, x and y are current pixel positions, a_{x,y}ⁱ is an input value, that is, an output value of a neuron activation function, k, α, β and n/2 are all user-defined coefficients, and N is the total number of channels. Finally, the sum of squares accumulated by different channels is calculated to obtain a local normalization result.

### 2. Make Sample Data

In one example, an original color image is sub-sampled to obtain a low-resolution image, the low-resolution image is subjected to Sobel operator filtration to obtain a Sobel operator edge image, and data of 4 bands, that is, data of red, green and blue bands and data of the Sobel edge operator band, are obtained. The data of these 4 bands are interpolated, so that the resolution is the same as that of the original image, and the up-sampled data of these 4 bands are taken as sample data.

Sobel is a classic edge detection method. A Sobel operator consists of two groups of 3×3 small templates, which are horizontal templates and vertical templates respectively. The templates are convolved with the image to obtain horizontal and vertical luminance difference values. Assuming that A is an image slice and Gx and Gy are horizontal and vertical convolution templates respectively, the calculation formula is as follows:

$${G}_{x} = [ \begin{matrix}- 1 & 0 & + 1 \\ - 2 & 0 & + 2 \\ - 1 & 0 & + 1\end{matrix} ] ⋆ A$$

$${G}_{y} = [ \begin{matrix}- 1 & - 2 & - 1 \\ 0 & 0 & 0 \\ + 1 & + 2 & + 1\end{matrix} ] ⋆ A$$

An edge gradient of a current pixel of the image may be obtained by adding the sum of squares of horizontal calculation results and vertical calculation results, and then extracting a root. The calculation formula is as follows:

G=\sqrt{Gₓ²+G_{y}²}

### 3. Make Labeled Data

In one example, the labeled data are made using a standard Unsharp Mask (USM) sharpening method. USM sharpening, as a good image sharpening method, may sharpen image edges and quickly adjust the contrast of image edge details. USM sharpening involves three parameters. A first parameter is number, which controls the intensity of the sharpening effect. A second parameter is radius, which specifies the radius of sharpening. The radius determines the number of pixels that affect sharpening around an edge pixel. The higher the resolution of the image is, the larger the radius should be. A third parameter is threshold, which refers to a comparison value between adjacent pixels. These parameters determine how much the hue of a pixel must be different from its surrounding pixels so that it is regarded as an edge pixel, and then the pixel is sharpened with a USM filter.

In one example, the labeled data are obtained by sharpening original data, and a USM method is adopted for sharpening. The parameters are set as follows: the threshold is 3, the radius is 1, and the number is 20%. In this way, the labeled data for training are obtained for image sharpening. The three parameters in the USM algorithm are empirical values obtained through multiple experiments, and this numerical combination is optimal. If the parameters are not set properly, over-fitting or under-fitting may be caused.

4. Train Neural Network with Sample Data and Labeled Data to Obtain Image Super-Resolution Model

The training process is as follows: inputting the sample data into the super-resolution image generation neural network to obtain an output super-resolution image; comparing the labeled data with the output super-resolution image, and adjusting the parameters of the super-resolution image generation neural network if a similarity between the labeled data and the output super-resolution image does not reach a preset standard; and repeating the process of inputting sample data into the super-resolution image generation neural network, comparing the labeled data with the output images of the super-resolution image generation neural network, and determining whether to adjust the parameters of the super-resolution image generation neural network according to comparison results.

If the comparison result shows that the similarity between the labeled data and the output super-resolution image reaches the preset standard, the parameters of the image super-resolution neural network will not be adjusted, and the training is completed.

### 5. Perform Super-Resolution Calculation on Input Image by Means of Trained Super-Resolution Model to Obtain Super-Resolution Image

The trained super-resolution model, whose neural network parameters have been adjusted to a perfect state, may be used to complete the task of converting low-resolution pictures into super-resolution pictures.

FIG. 3 is a diagram of an image super-resolution reconstruction device. As shown in FIG. 3, the device comprises a super-resolution image generation neural network module 101 for obtaining a super-resolution image according to an input low-resolution image; a sample data generation module 103 for performing low-resolution processing on an original image to obtain training sample data of the super-resolution image generation neural network module 101; and a labeled data generation module 105 for sharpening the original image to obtain training labeled data of the super-resolution image generation neural network module 101; wherein, the super-resolution image generation neural network module 101 is used for training according to the sample data and the label data to obtain a mature super-resolution image generation neural network; and an input image is calculated by the mature super-resolution image generation neural network to obtain a super-resolution image of the input image.

Preferably, the super-resolution image generation neural network module 101 comprises multiple layers of convolution calculation subunits, and at least part of the multiple layers of convolution calculation subunits adopt narrow convolution.

In one example, a 6-layer super-resolution image generation neural network is established, and the input data of the super-resolution image generation neural network are data of 4 channels composed of color images and a Sobel channel. A first convolution layer with 64 features is obtained through convolution of the input data with a 5×5 template, a second convolution layer with 128 features is obtained through convolution with a 3×3 template, a third convolution layer with 32 features is obtained through convolution with a 7×7 template, a fourth convolution layer with 16 features is obtained through convolution with a 3×3 template, a fifth convolution layer with 8 features is obtained through convolution with a 3×3 template, and a sixth convolution layer with 3 features is obtained through convolution with a 3×3 template. In the sixth layer, the final super-resolution result will be yielded.

Specifically, the convolution calculation subunits of each layer of the super-resolution image generation neural network are subjected to LRN. The calculation formula is as follows:

$${b}_{x , y}^{i} = {a}_{x , y}^{i} / {( k + α {\sum }_{j = max ( 0 , i - n / 2 )}^{min ( N - 1 , i + n \text{/2} )} {( {a}_{x , y}^{j} )}^{2} )}^{β}$$

where b_{x,y}ⁱ is a normalized value, i is an input channel, x and y are current pixel positions, a_{x,y}ⁱ is an input value, that is, an output value of a neuron activation function, k, α, β and n/2 are all user-defined coefficients, and N is the total number of channels.

In the convolution calculation process of each layer of the super-resolution image generation neural network, a narrow convolution strategy is adopted, and the image becomes smaller after each layer of convolution calculation.

Preferably, the sample data generation module 103 further comprises: a subunit for performing sub-sampling on an original image to obtain a low-resolution image; a subunit for performing Sobel operator filtering on the obtained low-resolution image to obtain a Sobel operator edge image; and a subunit for performing interpolation calculation on data of 4 bands, that is, data of red, green and blue bands of the low-resolution image and data of the Sobel operator edge image, to obtain an image with the same resolution as the original image as the sample data.

Preferably, the labeled data generation module 105 adopts USM sharpening, and the USM sharpening is conducted by the following parameters: the threshold value is 3, the radius is 1-1.2, and the number is 20%-25%.

Some picture changes and effect comparison in the method steps and results of the embodiment of the application are shown below based on actual picture effects.

By using the method provided by the embodiment of the application, the actual effect and data comparison obtained in an example are as follows:

FIG. 4 is a comparison diagram of original data and sample data obtained by sub-sampling and then interpolation. The left part of the diagram shows the original data, and the right part shows the sample data obtained after sub-sampling and then interpolation. By comparison, it can be found that the original data have higher resolution, clearer image and finer texture than the sample experimental data, while the sample data obtained after sampling and then interpolation are obviously fuzzy and the edges are not clear, so such data can be used as the sample data of the training model.

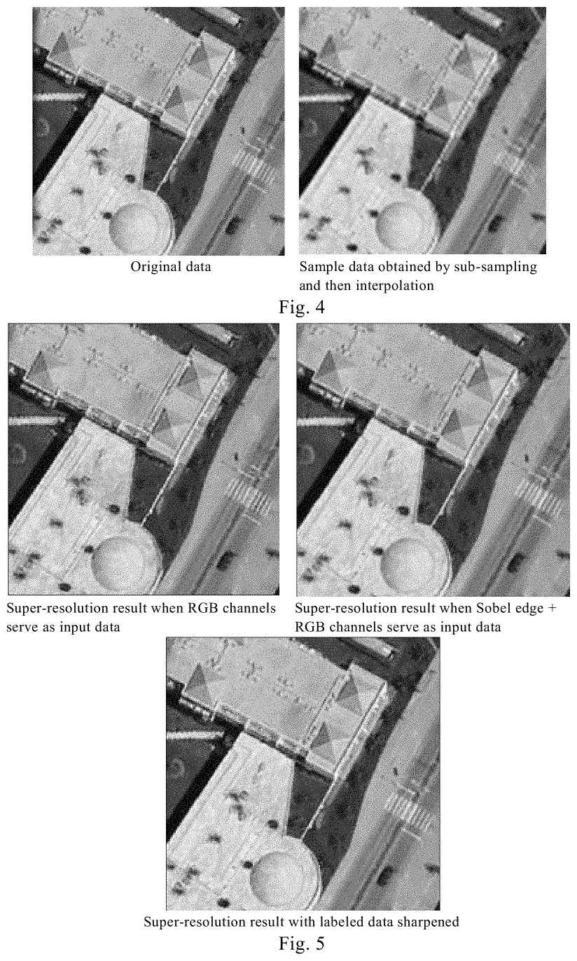

FIG. 5 is a comparison diagram of super-resolution results obtained when RGB channels serve as input data, when Sobel edge+RGB channels serve as input data, and when labeled data are sharpened.

On the premise of changing the input data and the labeled data but not the network model of FIG. 2, three specific models are designed in this embodiment. In a first model, input data are sample data of red, green and blue bands, and labeled data are original data. In a second model, input data are data of four bands, that is, data of red, green and blue bands and data of the Sobel edge operator band, and labeled data are original data. In a third model, input data are data of 4 bands, that is, data of red, green and blue bands and data of the Sobel edge operator band, and labeled data are USM sharpening data.

In the evaluation of image super-resolution results, it is necessary to compare the original image with the results, as well as the results of different methods. Subjective visual comparison and several commonly used quantitative evaluation indexes are used for evaluation. After the image is subjected to super-resolution, there may be regional differences such as false edges, noise and blur, so the evaluation indexes may be not objective. Therefore, subjective visual evaluation is very important and can not be ignored, and qualitative evaluation takes precedence over quantitative evaluation.

Through training, three models were obtained, and the data were subjected to super-resolution calculation respectively. The calculation results are shown in the upper left, upper right and lower parts of the figure. Comparing the sampled data with the super-resolution results, we can find that the resolution and definition of the three super-resolution results are obviously improved compared with the sample data, which shows that the model in the embodiment of the application is effective to some extent. Comparing the original data with the super-resolution results, we can find that without blowing up the images, there is little difference or even no obvious difference between these images, which shows that the super-resolution model in the embodiment of the application is a good convolutional neural network model which can improve the resolution and definition of images, and also shows that the model in the embodiment of the application achieves the purpose of improving the image resolution.

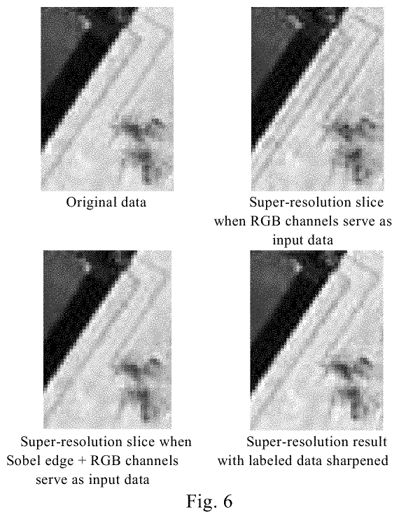

In order to further qualitatively analyze whether the super-resolution image of the model has an over-fitting effect, it is necessary to blow up the image for more detailed comparison, as shown in FIG. 6. After enlarging the image, by comparison, it can be found that when a model only uses RGB color images as training data, the image super-resolution results have obvious false edges, which shows that although the LRN technology for eliminating over-fitting is adopted in the convolutional neural network model, the results obtained by using the color images of only three bands as sample training data are still not ideal. By adding the Sobel edge operator to the training data, experiments with the trained super-resolution model show no obvious false edges. Similarly, when a model is trained by using images containing the Sobel operator as training data and USM sharpening images as labeled data, the image super-resolution results have no over-fitting effect, which also proves that adding the edge detection operator to the training sample data may effectively improve the quality of super-resolution images.

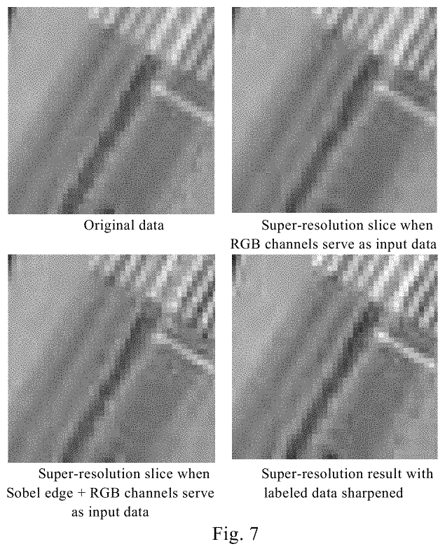

Then the different super-resolution results are compared with the original data, and the image definition is analyzed by enlarging the images, as shown in FIG. 7. It can be found that the super-resolution results are not as clear as the original data, and the edges of the original data are clearer, that is to say, the super-resolution results can not achieve the visual effect of the original data from the perspective of both principle and common sense, and their edges are not as clear as the original data. Comparing the super-resolution results of red, green and blue bands, the super-resolution results of Sobel plus red, green and blue bands and the super-resolution results of sharpening labeled data, we can find that the super-resolution results of sharpening labeled data are better than the other two methods in edge features, which shows that the super-resolution method featuring labeled data sharpening is a better idea, and it is a method that can eliminate the blurring of super-resolution images to a great extent. Through the comparison of the 3 super-resolution results and their comparison with the original data, we can see that the edge of the super-resolution result of the model obtained by labeled data sharpening training is clearer and closer to the original data, which is the best among the three results.

Next, the effects of the methods in the embodiment of the application are compared based on data indexes.

Generally speaking, the indexes for image quality evaluation are some statistical indexes, including definition, peak signal-to-noise ratio (PSNR), structural similarity (SSIM) and root mean square error (RMSE). The super-resolution result images obtained by different methods were quantitatively evaluated, and the calculation results are shown in Table 1.

TABLE 1
Super-resolution image calculation indexes of different methods

| | 3 Band | 4 Band | Label image |
|---|---|---|---|
| | imagesuper- | imagesuper- | sharpening |
| | resolution | resolution | super-resolution |
| Definition | 13.78 | 12.41 | 14.02 |
| RMSE | 11.75 | 8.25 | 7.35 |
| PSNR | 2.65 | 5.74 | 6.74 |
| SSIM | 0.92 | 0.93 | 0.96 |

By analyzing this table, we can find that the results obtained by performing super-resolution reconstruction on the data when the network model is trained by sharpening the labeled data are better than the results obtained by the other two methods in four evaluation indexes. Because the labeled data are the result of sample sharpening, it is easy to understand that its definition is better than the results obtained by the other two methods. RMSE is the calculation result of the difference between the super-resolution result and the original labeled data. The smaller the value, the closer the original labeled image is to the super-resolution result. Comparing the RMSEs calculated by these methods, we can find that the super-resolution result obtained by the labeled data sharpening method is closer to the original data and the definition is higher, and that the results of the other two methods are quite different from the original data and the definition is lower, which proves the superiority of the embodiment of the application. PSNR is a statistic index for comparing the signal intensity with the background noise intensity. By comparison, it can be found that the PSNR of the labeled image sharpening super-resolution result of the embodiment of the application is the largest, that is to say, the embodiment of the application may suppress the generation of noise and improve the information amount at the same time. SSIM is used to evaluate the quality of super-resolution images from three aspects: image brightness similarity, image contrast similarity and image structure similarity. By comparing the structural similarity indexes of the result images obtained by the three methods, it can be found that the results of the label sharpening super-resolution method in the embodiment of the application are better than those of the other two methods.

Comparing the super-resolution result when input data contain red, green and blue bands with the super-resolution result when input data contain Sobel plus red, green and blue bands based on these four indexes, we can find that except definition, the model calculation results of the four-band sample data are all better than those of three-band sample data in the other three indexes. The reason why the super-resolution result when input data contain red, green and blue bands has a good definition is that false edges caused by over-fitting exist, but not that the image quality is good. This comparison also proves that the super-resolution result involving the edge operator is better.

It can be seen from the above embodiments that the image super-resolution reconstruction method and device featuring labeled data sharpening disclosed in the application have the following advantages: by sharpening the labeled data to a certain extent, edges of the labeled data are clearer and object features are easier to see; a model is obtained by training a deep neural network, and the model is used to perform super-resolution processing on the image to obtain an image with a higher resolution; and the obtained image has a clear texture, the resolution and definition are significantly improved, and the quality evaluation indexes of the image are better.

All the embodiments in this specification are described in a progressive way, and the same and similar parts of different embodiments can serve as references for each other. Each embodiment focuses on its differences from other embodiments. As the system embodiments are basically similar to the method embodiments, the description is relatively simple, and please refer to the description of the method embodiments for relevant information.

According to an embodiment in another aspect, computing equipment is provided, which comprises a memory and a processor, the memory stores executable codes, and when the processor executes the executable codes, the method described above is realized.

Specific embodiments of this specification have been described above. Other embodiments are within the scope of the appended claims. In some cases, the actions or steps recorded in the claims may be performed in a different order than in the embodiments and still achieve the desired results. In addition, the processes depicted in the drawings are not necessarily in the specific order or continuous order shown to achieve the desired results. In some embodiments, multitasking and parallel processing are also possible or may be advantageous.

Those of ordinary skill in the art should further realize that the units and algorithm steps of each example described in connection with the embodiments disclosed herein may be realized by electronic hardware, computer software or a combination of both. In order to clearly illustrate the interchangeability of hardware and software, the components and steps of each example have been generally described above in terms of functions. Whether these functions are implemented by hardware or software depends on the specific application and design constraints of the technical scheme. One of ordinary skill in the art may use different methods to realize the described functions for each specific application, but this realization should not be considered beyond the scope of the application.

The steps of a method or algorithm described in connection with the embodiments disclosed herein may be implemented in hardware, a software module executed by a processor, or a combination of the two. The software module can be placed in a random access memory (RAM), memory, read-only memory (ROM), electrically programmable ROM, electrically erasable programmable ROM, register, hard disk, removable magnetic disk, CD-ROM, or any other form of storage medium known in the technical field.

The above-mentioned specific embodiments further explain the purpose, technical scheme and beneficial effects of the application in detail. It should be understood that the above embodiments are only specific ones of the application and are not used to limit the scope of protection of the application. Any modification, equivalent substitution, improvement, etc. made based on the spirit and principle of the application should be included in the scope of protection of the application.

1. An image super-resolution reconstruction method, comprising:
inputting sample data into a pre-established super-resolution image generation neural network, the sample data being obtained by low-resolution processing of an original image;
extracting, by the super-resolution image generation neural network, image features according to a low-resolution image input by the sample data, and then reconstructing the image according to the extracted image features to obtain a super-resolution image;
adjusting parameters of the super-resolution image generation neural network if a similarity between the super-resolution image and labeled data does not reach a preset standard, the labeled data being obtained by sharpening the original image; and
inputting a low-resolution image into a trained super-resolution image generation neural network to obtain a super-resolution image.

2. The image super-resolution reconstruction method according to claim 1, wherein the super-resolution image generation neural network involves multi-layer convolution calculation, and at least part of the multi-layer convolution calculation adopts narrow convolution.

3. The image super-resolution reconstruction method according to claim 1, wherein the super-resolution image generation neural network involves multi-layer convolution calculation, and each layer of convolution calculation adopts local response normalization (LRN).

4. The image super-resolution reconstruction method according to claim 1, comprising:
performing sub-sampling calculation on the original image to obtain the low-resolution image;
performing Sobel operator filtering calculation on the obtained low-resolution image to obtain a Sobel edge image; and
performing interpolation calculation on data of 4 bands, that is, data of red, green and blue bands of the low-resolution image and data of the Sobel edge image, to obtain an image with the same resolution as the original image as the sample data.

5. The image super-resolution reconstruction method according to claim 1, comprising:
obtaining the labeled data from an original image through sharpening calculation, wherein the sharpening calculation is conducted through USM sharpening, and the USM sharpening is conducted by the following parameters: a threshold value is 3, a radius is 1-1.2, and a number is 20%-25%.

6. An image super-resolution reconstruction device, comprising:
a sample data generation module for performing low-resolution processing on an original image to obtain training sample data of a super-resolution image generation neural network module;
a labeled data generation module for sharpening the original image to obtain training labeled data of the super-resolution image generation neural network module; and
a super-resolution image generation neural network module for training according to the sample data and the labeled data, wherein an input image is calculated by the trained super-resolution image generation neural network module to obtain a super-resolution image of the input image.

7. The image super-resolution reconstruction device according to claim 6, wherein the super-resolution image generation neural network comprises multiple layers of convolution calculation subunits, and at least part of the multiple layers of convolution calculation subunits adopt narrow convolution.

8. The image super-resolution reconstruction device according to claim 6, wherein the super-resolution image generation neural network comprises multiple layers of convolution calculation subunits, and each layer of convolution calculation subunits adopts local response normalization (LRN).

9. The image super-resolution reconstruction device according to claim 6, comprising:
a subunit for performing sub-sampling calculation on the original image to obtain a low-resolution image;
a subunit for performing Sobel operator filtering calculation on the obtained low-resolution image to obtain a Sobel edge image; and
a subunit for performing interpolation calculation on data of 4 bands, that is, data of red, green and blue bands of the low-resolution image and data of the Sobel edge image, to obtain an image with a same resolution as the original image as the sample data.

10. The image super-resolution reconstruction device according to claim 6, wherein the labeled data generation module adopts USM sharpening, and the USM sharpening is conducted by the following parameters: a threshold value is 3, a radius is 1-1.2, and a number is 20%-25%.
